(19) United States
(12) Patent Application Publication
(10) Pub. No.: US 2020/0203814 A1
(43) Pub. Date: Jun. 25, 2020

(54) VEHICLE ANTENNA MODULE AND ASSEMBLING METHOD THEREOF

(71) Applicants: LITE-ON ELECTRONICS (GUANGZHOU) LIMITED, GUANGZHOU (CN); Lite-On Technology Corporation, Taipei (TW)

(72) Inventors: Zhen-Zhe Weng, Taipei (TW); Ju-Wen Teng, Taipei (TW); Chia-Tai Tsai, Taipei (TW); Meng-Chang Chiu, Taipei (TW)

(73) Assignees: LITE-ON ELECTRONICS (GUANGZHOU) LIMITED, GUANGZHOU (CN); Lite-On Technology Corporation, Taipei (TW)

(21) Appl. No.: 16/547,620

(22) Filed: Aug. 22, 2019

Related U.S. Application Data
(60) Provisional application No. 62/782,332, filed on Dec. 19, 2018.

(30) Foreign Application Priority Data
Jul. 5, 2019 (CN) 201910602913.3

(51) Int. Cl. H01Q 1/32; H01Q 1/12; H01Q 1/52

(52) U.S. Cl. CPC H01Q 1/3275; H01Q 1/521; H01Q 1/1214

(57) ABSTRACT

A vehicle antenna module is adapted to be assembled with a vehicle roof plate and includes a Telematics-Box and an antenna assembly. The Telematics-Box is fixed on the vehicle roof plate and includes at least one first sliding portion, at least one first latching portion and a first connector. The first sliding portion, the first latching portion and the first connector protrude out of at least one assembling hole in the vehicle roof plate. The antenna assembly is slidably arranged on the Telematics-Box, and the vehicle roof plate is located between the antenna assembly and the Telematics-Box. The antenna assembly includes at least one second sliding portion, at least one second latching portion and a second connector. When the second sliding portion slides along the first sliding portion, the second latching portion is latched to the first latching portion, and the second connector is electrically connected to the first connector.

### CROSS-REFERENCE TO RELATED APPLICATION

This application claims the priority benefits of U.S. provisional application Ser. No. 62/782,332, filed on Dec. 19, 2018, and China application serial no. 201910602913.3, filed on Jul. 5, 2019. The entirety of each of the above-mentioned patent applications is hereby incorporated by reference herein and made a part of this specification.

### BACKGROUND OF THE INVENTION

### 1. Field of the Invention

The present invention relates to an antenna module and an assembling method thereof, in particular to a vehicle antenna module and an assembling method thereof.

### 2. Description of Related Art

The existing Telematics-Box is an antenna module which is provided in or near a dashboard and electrically connected to the top of a vehicle roof plate at the rear by means of wire connection. However, when signals are transmitted through wires between the antenna module and the Telematics-Box, since the transmission path is from the rear of the vehicle roof to the front of the vehicle roof, the transmission path is long, the high-frequency communication loss is easily increased, the amount of used coaxial cables is also increased and the production cost is increased.

### SUMMARY OF THE INVENTION

Accordingly, the present invention is directed to a vehicle antenna module, which has a short signal transmission path between a Telematics-Box and an antenna assembly thereof, and has better communication quality.

The present invention is directed to an assembling method of a vehicle antenna module, which is used for assembling the above vehicle antenna module.

The vehicle antenna module in the present invention is adapted to be assembled with a vehicle roof plate and includes a Telematics-Box and an antenna assembly. The Telematics-Box is fixed on the vehicle roof plate and includes at least one first sliding portion, at least one first latching portion and a first connector. The first sliding portion, the first latching portion and the first connector protrude out of at least one assembling hole in the vehicle roof plate. The antenna assembly is slidably arranged on the Telematics-Box, and the vehicle roof plate is located between the antenna assembly and the Telematics-Box. The antenna assembly includes at least one second sliding portion, at least one second latching portion and a second connector. When the second sliding portion slides along the first sliding portion, the second latching portion is latched to the first latching portion, such that the second connector is electrically connected to the first connector.

According to the embodiment of the present invention, one of the first sliding portion and the second sliding portion is a sliding groove, and the other of the first sliding portion and the second sliding portion is a sliding block.

According to the embodiment of the present invention, one of the first latching portion and the second latching portion is an elastic latching block, and the other of the first latching portion and the second latching portion is a latching groove.

According to the embodiment of the present invention, the vehicle antenna module further includes at least one locking member, and the Telematics-Box further includes at least one fixed portion. The locking member penetrates through the vehicle roof plate and is locked on the fixed portion, such that the Telematics-Box is fixed to the vehicle roof plate.

According to the embodiment of the present invention, the Telematics-Box further includes a housing and a circuit board. The housing includes an opening, the circuit board is configured in the housing, and the opening exposes a part of the circuit board. The first sliding portion and the first latching portion are located on the housing. The first connector is electrically connected with the circuit board, penetrates through the opening and is exposed outside the housing.

According to the embodiment of the present invention, the antenna assembly further includes a base, and the base is provided with a bottom surface and an opening. The second sliding portion and second latching portion are arranged on the bottom surface of the base, and the second connector penetrates through the opening and is exposed outside the base.

According to the embodiment of the present invention, the antenna assembly further includes a waterproof ring, and the waterproof ring is configured on the bottom surface of the base.

According to the embodiment of the present invention, the vehicle antenna module further includes at least one locking member. The antenna assembly further includes a base, a circuit board and at least one antenna element. The antenna element and the second connector are respectively arranged on two opposite sides of the circuit board and electrically connected to the circuit board. The circuit board is fixed on the base through the locking member.

According to the embodiment of the present invention, the antenna element includes a 4G/LTE (Long Term Evolution) antenna, a GPS (Global Positioning System) active antenna or an AM/FM wound antenna. The 4G/LTE antenna includes two helical cylindrical antennas and two flexible circuit board antennas. The two flexible circuit board antennas are opposite to each other and are located between the two helical cylindrical antennas.

According to the embodiment of the present invention, the antenna assembly further includes a cover body and at least one antenna element. The cover body is internally provided with at least one stabilizing plate, and the stabilizing plate is provided with a positioning surface and a supporting surface. The supporting surface is connected to the positioning surface, and the antenna element is attached to the supporting surface. The positioning surface is provided with a first positioning portion, and the antenna element is provided with a second positioning portion. The second positioning portion is positioned at the first positioning portion such that the antenna element is positioned on the positioning surface. One of the first positioning portion and the second positioning portion is a positioning column, and the other of the first positioning portion and the second positioning portion is a positioning hole.

According to the embodiment of the present invention, the vehicle antenna module further includes at least one locking member, the antenna assembly further includes a base, and the cover body is fixed on the base through the locking member.

According to the embodiment of the present invention, the antenna assembly further includes at least one oblique surface portion, and each of the at least one second sliding portion includes two branches separated by a groove. Each of the at least one oblique surface portion is connected with the two branches, wherein each of the at least one oblique surface portion is connected to the two branches and is located between the groove and each of the second latching portion.

The assembling method for the vehicle antenna module in the present invention includes the following steps: fixing a Telematics-Box to a vehicle roof plate, the Telematics-Box including at least one first sliding portion, at least one first latching portion and a first connector, the first sliding portion, the first latching portion and the first connector protruding out of at least one assembling hole in the vehicle roof plate; providing an antenna assembly on the vehicle roof plate, the vehicle roof plate being located between the antenna assembly and the Telematics-Box, the antenna assembly including at least one second sliding portion, at least one second latching portion and a second connector; and applying a first force to the antenna assembly such that, when the second sliding portion slides along the first sliding portion, the second latching portion is latched to the first latching portion and the second connector is electrically connected to the first connector, and accordingly, the antenna assembly is slidably arranged on the Telematics-Box.

According to the embodiment of the present invention, the antenna assembly further includes at least one oblique surface portion, and each of the second sliding portion includes two branches separated by a groove. Each of the oblique surface portion is connected with the two branches, wherein each of the oblique surface portion is connected to the two branches and is located between the groove and each of the second latching portion. When the first force is applied to the antenna assembly, the first latching portion guides the oblique surface portion to move towards a first direction, such that the second latching portion is latched to the first latching portion.

According to the embodiment of the present invention, the method further includes: applying a second force to the antenna assembly to deform the first latching portion; and applying a third force to the antenna assembly such that, when the oblique surface portion moves towards a second direction opposite to the first direction, the second latching portion does not interfere with the first latching portion, the second sliding portion does not interfere with the first sliding portion, and the second connector does not interfere with the first connector, and accordingly, the antenna assembly is disassembled from the Telematics-Box.

According to the embodiment of the present invention, the step of fixing the Telematics-Box to the vehicle roof plate includes: providing at least one locking member, the Telematics-Box further including at least one fixed portion; and enabling the locking member to penetrate through the vehicle roof plate and be locked on the fixed portion, such that the Telematics-Box is fixed on the vehicle roof plate.

According to the embodiment of the present invention, the step of providing the antenna assembly includes: providing a base, the base being provided with a bottom surface and an opening, the sliding portion and second latching portion being arranged on the bottom surface of the base; fixing a circuit board provided with at least one antenna element on the base, the antenna element and the second connector being respectively arranged on two opposite sides of the circuit board and electrically connected to the circuit board, the second connector penetrating through the opening and being exposed outside the base; and fixing a cover body on the base, the cover body covering the circuit board and the antenna element.

Based on the above, in the design of the vehicle antenna module in the present invention, the Telematics-Box is fixed on the vehicle roof plate, the antenna assembly is slidably arranged on the Telematics-Box, and the second connector of the antenna assembly is electrically connected to the first connector of the Telematics-Box. Compared with the method of electrically connecting the Telematics-Box and the antenna module by means of wire connection, the vehicle antenna module in the present invention can directly convert radio communication analog signals received by the antenna module into digital signals through the Telematics-Box, which can effectively reduce interference and reduce the high-frequency communication loss, can also reduce the amount of used coaxial cables, and thus reduces the production cost.

To make the aforementioned more comprehensible, several embodiments accompanied with drawings are described in detail as follows.

### BRIEF DESCRIPTION OF THE DRAWINGS

The accompanying drawings are included to provide a further understanding of the present utility model, and are incorporated in and constitute a part of this specification. The drawings illustrate embodiments of the present utility model and, together with the description, serve to explain the principles of the present utility model.

FIG. 1A is a stereoscopic view of a vehicle antenna module assembled on a vehicle roof plate according to one embodiment of the present invention.

FIG. 1B is a stereoscopic exploded view of FIG. 1A.

FIG. 1C is a partial cross-sectional stereoscopic view of FIG. 1A.

FIG. 2A is a stereoscopic schematic view of a Telematics-Box in FIG. 1A from another angle of view.

FIG. 2B is a stereoscopic schematic view of the Telematics-Box in FIG. 1 fixed on the vehicle roof plate.

FIG. 3A is a stereoscopic schematic view of a base of an antenna assembly in FIG. 1A from another angle of view.

FIG. 3B is a stereoscopic schematic view of a base of an antenna assembly according to another embodiment of the present invention.

FIG. 4A is a stereoscopic exploded schematic view of part of the antenna element and cover body of the antenna assembly in FIG. 1A.

FIG. 4B is a stereoscopic assembly schematic view of FIG. 4A.

FIG. 5A to FIG. 5B are cross-sectional views of an assembling method for the vehicle antenna module in FIG. 1A.

FIG. 5C is a stereoscopic schematic view of applying a force to an antenna assembly by adopting a disassembling tool.

FIG. 5D to FIG. 5E are cross-sectional views of an assembling method for the vehicle antenna module in FIG. 1A along another cross-section line.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

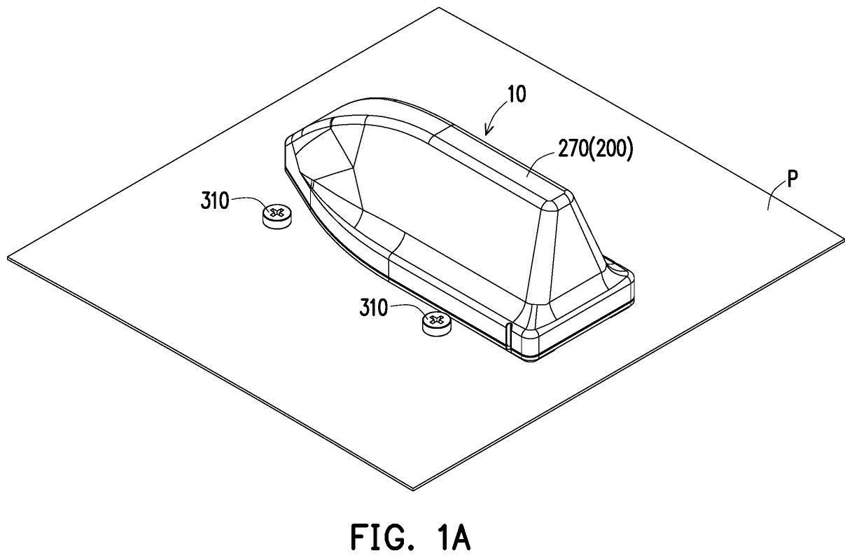

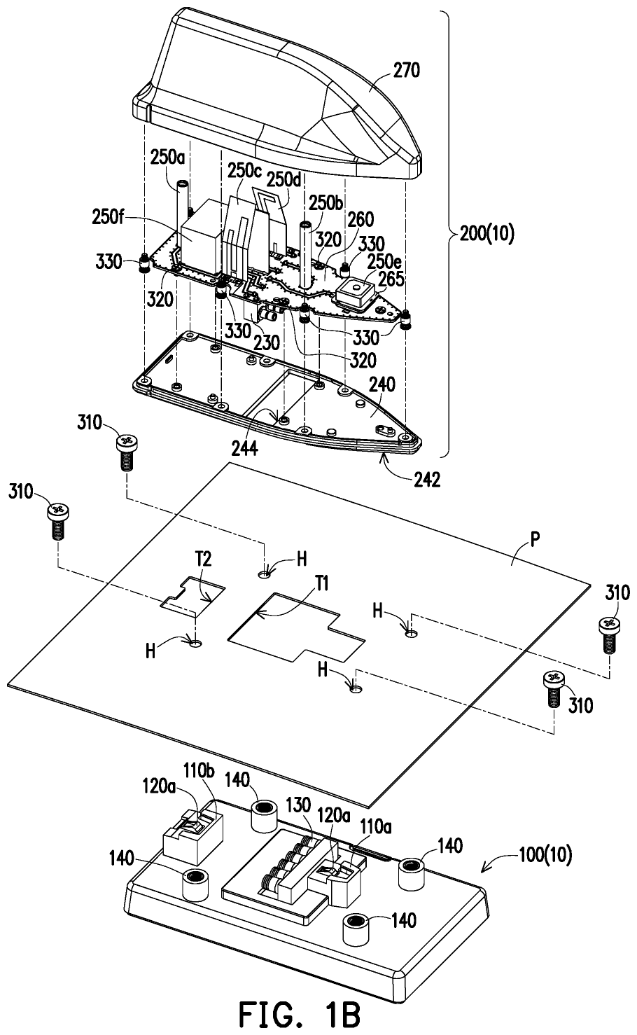

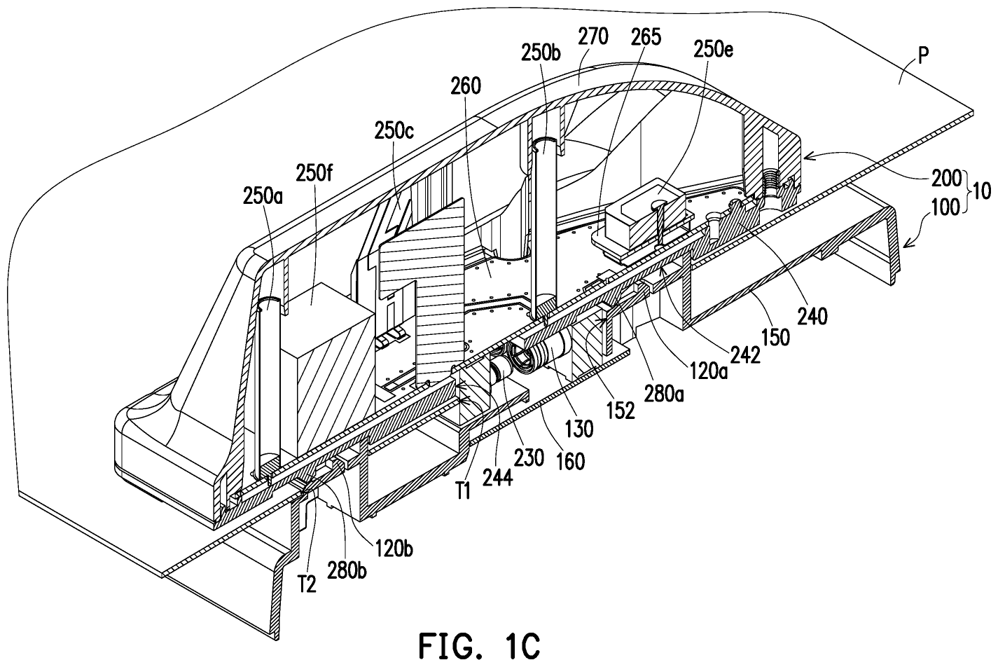

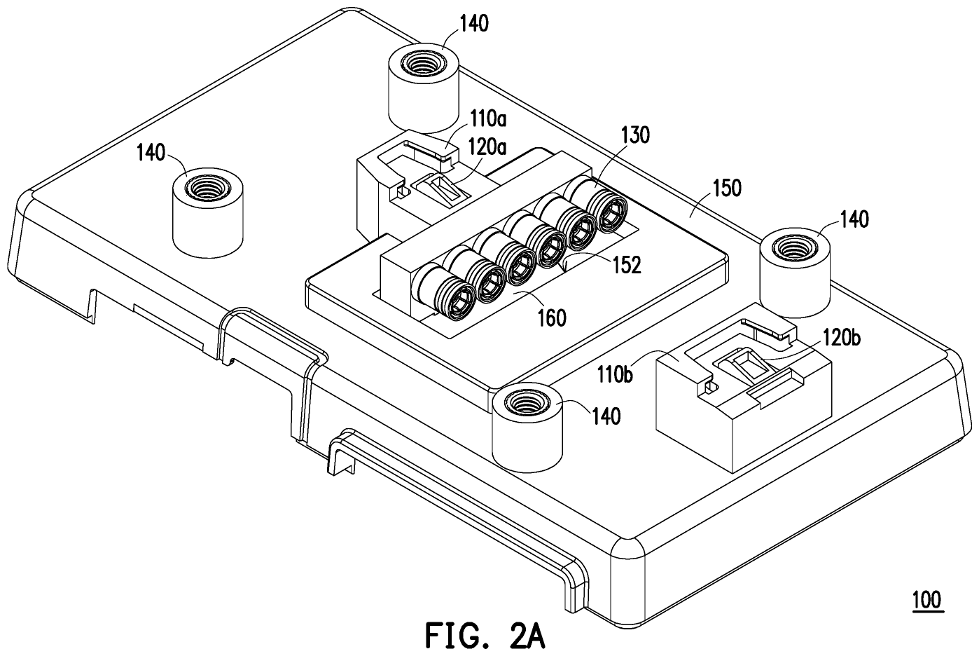

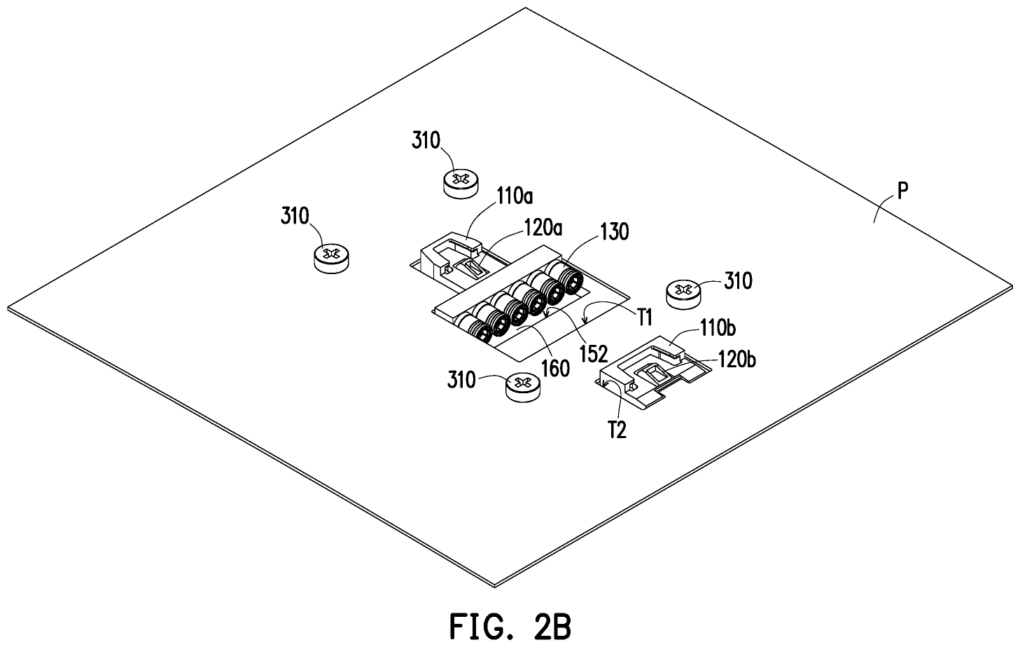

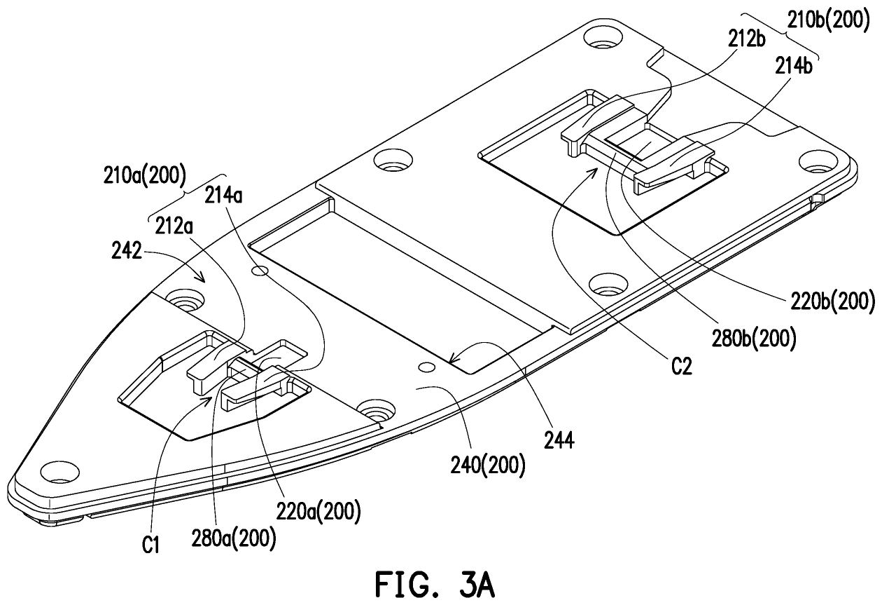

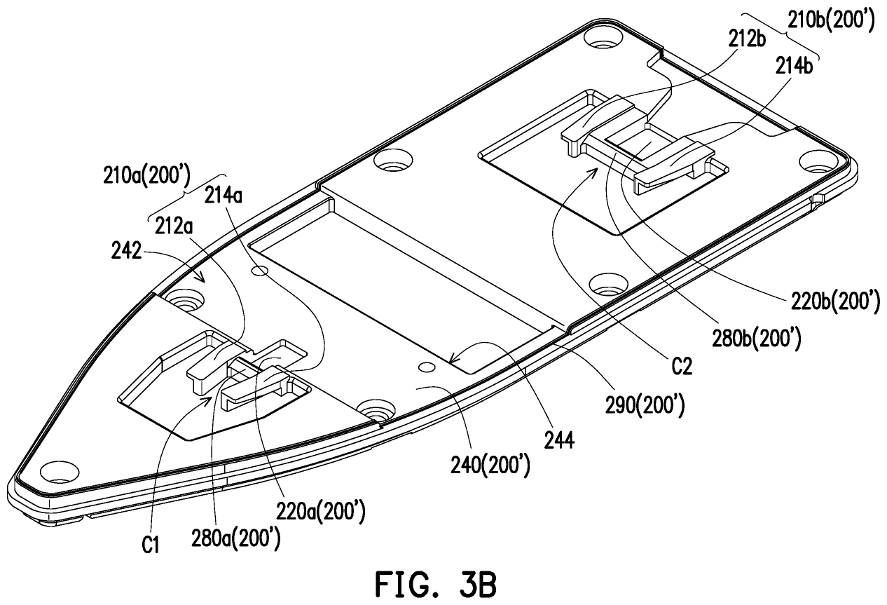

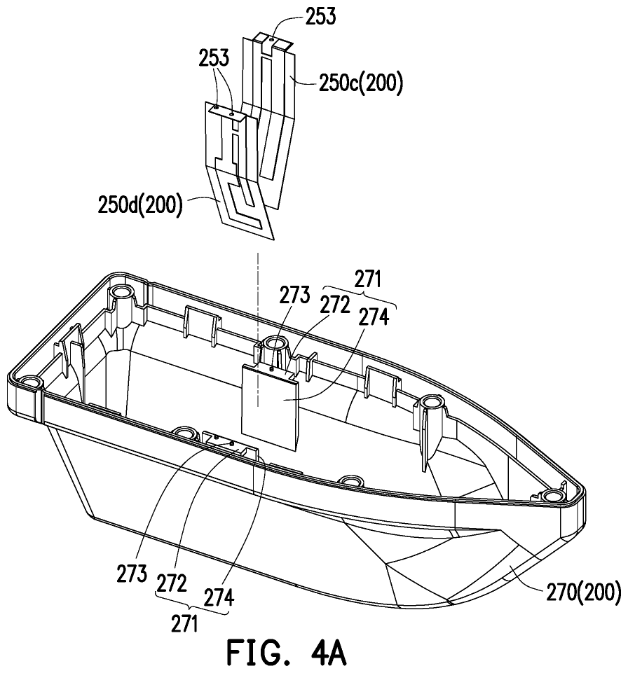

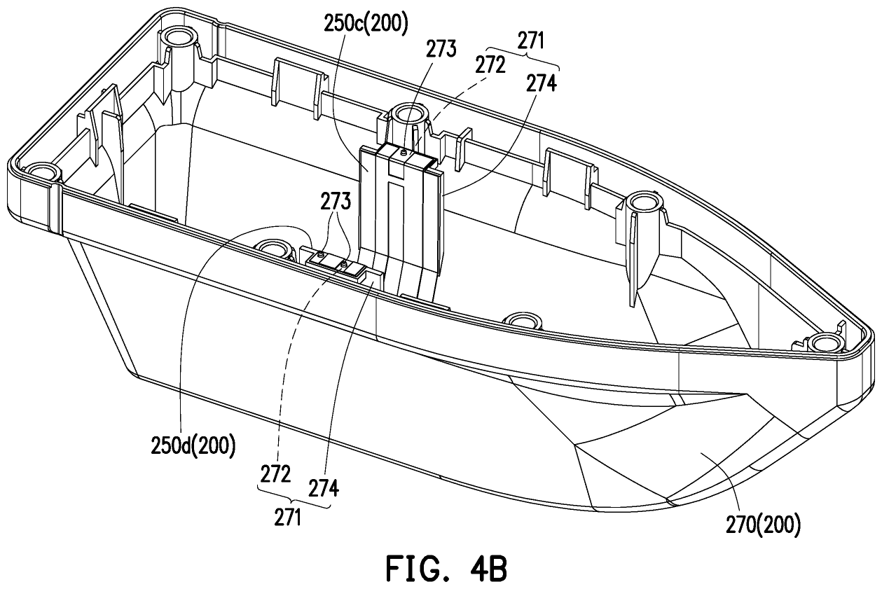

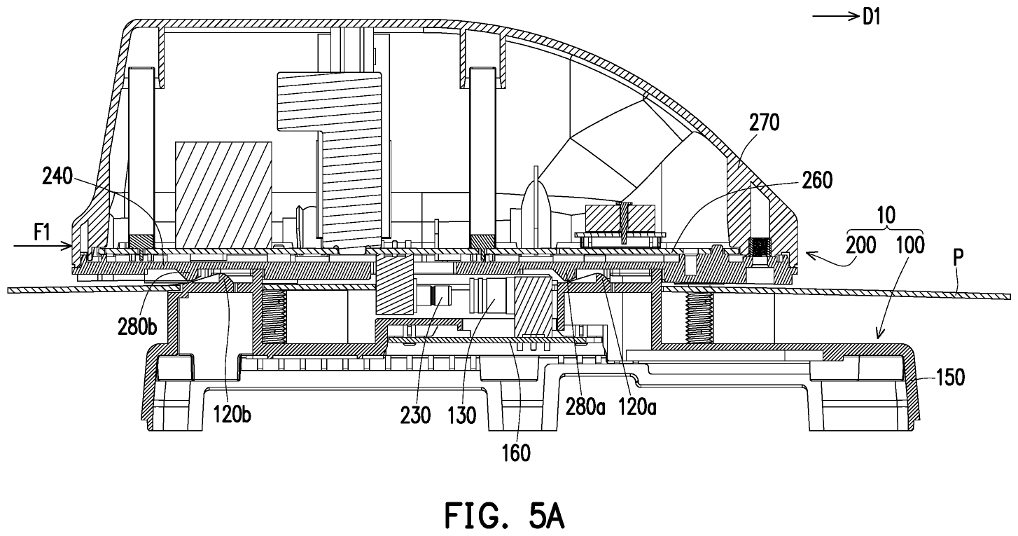

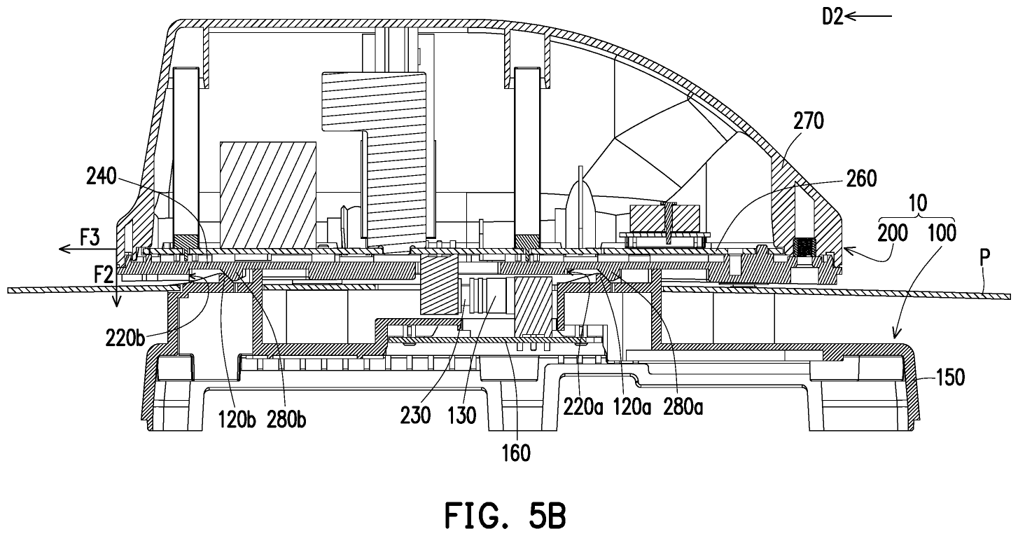

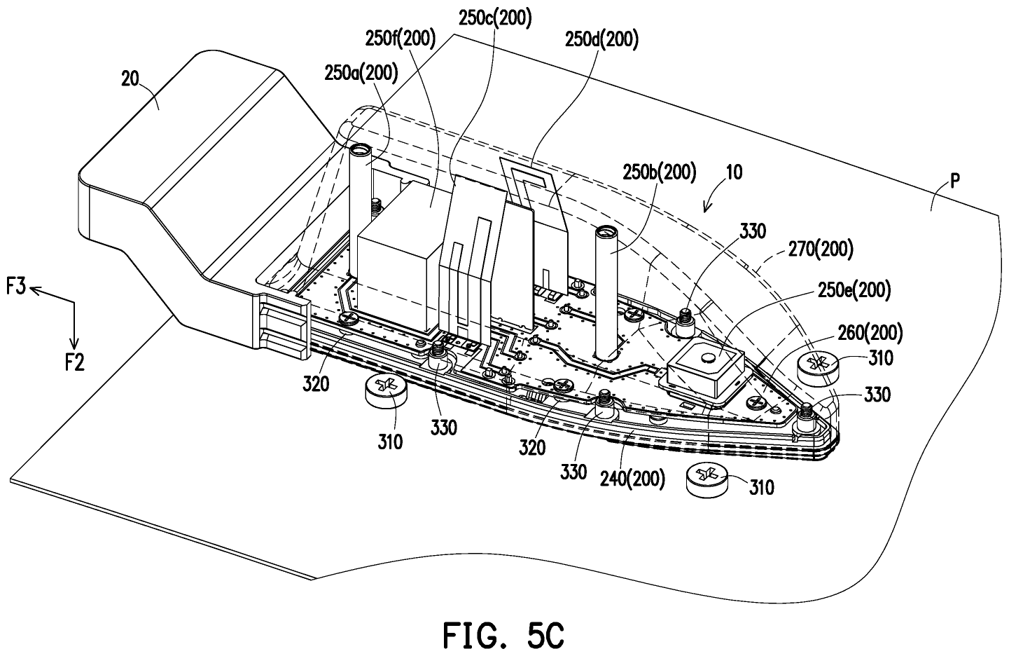

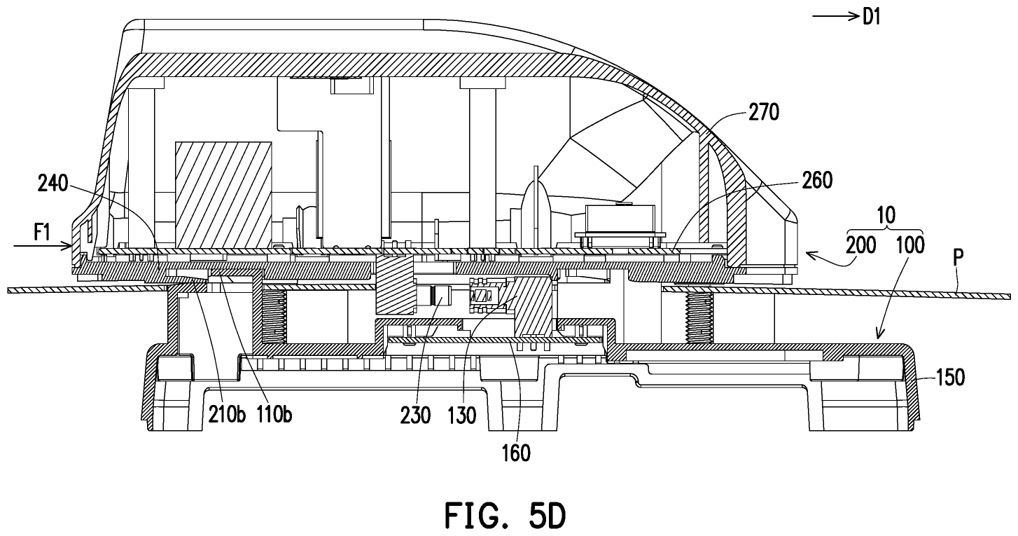

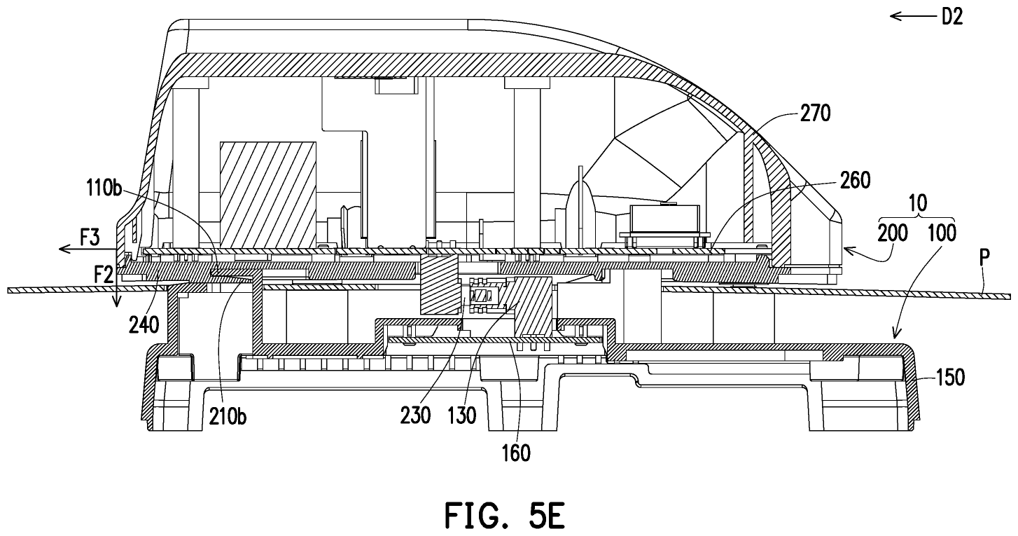

FIG. 1A is a stereoscopic view of a vehicle antenna module assembled on a vehicle roof plate according to one embodiment of the present invention. FIG. 1B is a stereoscopic exploded view of FIG. 1A. FIG. 1C is a partial cross-sectional stereoscopic view of FIG. 1A. FIG. 2A is a stereoscopic schematic view of a Telematics-Box in FIG. 1A from another angle of view. FIG. 2B is a stereoscopic schematic view of the Telematics-Box in FIG. 1 fixed on the vehicle roof plate. FIG. 3A is a stereoscopic schematic view of a base of an antenna assembly in FIG. 1A from another angle of view. FIG. 3B is a stereoscopic schematic view of a base of an antenna assembly according to another embodiment of the present invention. FIG. 4A is a stereoscopic exploded schematic view of part of the antenna element and cover body of the antenna assembly in FIG. 1A. FIG. 4B is a stereoscopic assembly schematic view of FIG. 4A. FIG. 5A to FIG. 5B are cross-sectional views of an assembling method for the vehicle antenna module in FIG. 1A. FIG. 5C is a stereoscopic schematic view of applying a force to an antenna assembly by adopting a disassembling tool. FIG. 5D to FIG. 5E are cross-sectional views of an assembling method for the vehicle antenna module in FIG. 1A along another cross-section line. For the sake of convenience in description, the cover body in FIG. 5C is illustrated by a dashed line.

Please firstly refer to FIG. 1A, FIG. 1B, FIG. 1C, FIG. 2A and FIG. 2B at the same time. In the present embodiment, the vehicle antenna module 10 is adapted to be assembled with a vehicle roof plate P, and the vehicle antenna module 10 includes a Telematics-Box 100 and an antenna assembly 200. In detail, the Telematics-Box 100 is fixed on the vehicle roof plate P and includes at least one first sliding portion (two first sliding portions 110a, 110b are schematically illustrated), at least one first latching portion (two first latching portions 120a, 120b are schematically illustrated) and a first connector 130. The first sliding portions 110a, 110b, the first latching portions 120a, 120b and the first connector 130 protrude out of at least one assembling hole (two assembling holes T1, T2 are schematically illustrated) in the vehicle roof plate P. Herein, the first sliding portion 110a, the first latching portion 120a and the first connector 130 protrude out of the assembling hole T1, and the first sliding portion 110b and the first latching portion 120b protrude out of the assembling hole T2.

Further, the Telematics-Box 100 further includes a housing 150 and a circuit board 160. The housing 150 includes an opening 152, the circuit board 160 is configured in the housing 150, and the opening 152 exposes a part of the circuit board 160. The first sliding portions 110a, 110b and the first latching portions 120a, 120b are located on the housing 150. The first connector 130 is electrically connected with the circuit board 160, penetrates through the opening 152 and is exposed outside the housing 150. Herein, the first latching portion 120a is located between the first sliding portion 110a and the first connector 130, and the first sliding portion 110b is located between the first connector 130 and the first latching portion 120b. The Telematics-Box 100 in the present embodiment further includes at least one fixed portion (four fixed portions 140 are schematically illustrated) configured on the housing 150, wherein the fixed portions 140 surround the first sliding portion 110a, the first latching portion 120a and the first connector 130. In order to effectively fix the Telematics-Box 100 and the vehicle roof plate P, the vehicle antenna module 10 in the present embodiment further includes at least one locking member (four locking members 310 are schematically illustrated), wherein the locking members 310 respectively penetrate through locking holes H in the vehicle roof plate P and are locked on the fixed portions 140, such that the Telematics-Box 100 is fixed to the vehicle roof plate P.

Please refer to FIG. 1B, FIG. 1C, FIG. 3A and FIG. 5B at the same time. The antenna assembly 200 in the present embodiment is slidably arranged on the Telematics-Box 100, and the vehicle roof plate 10 is located between the antenna assembly 200 and the Telematics-Box 100. The antenna assembly 200 includes at least one second sliding portion (two second sliding portions 210a, 210b are schematically illustrated), at least one second latching portion (two second latching portions 220a, 220b are schematically illustrated) and a second connector 230. When the second sliding portions 210a, 210b slide along the first sliding portions 110a, 110b, the second latching portions 220a, 220b are latched to the first latching portions 120a, 120b, such that the second connector 230 is electrically connected to the first connector 130.

More preferably, one of the first sliding portions 110a, 110b and the second sliding portions 210a, 210b is a sliding groove, and the other of the first sliding portions 110a, 110b and the second sliding portions 210a, 210b is a sliding block. Herein, the first sliding portions 110a and 110b are embodied as sliding groove, such as dovetail sliding grooves, and the second sliding portions 210a and 210b are embodied as sliding blocks. However, the present invention is not limited thereto. More preferably, one of the first latching portions 120a, 120b and the second latching portions 220a and 220b is an elastic latching block, and the other of the first latching portions 120a, 120b and the second latching portions 220a and 220b is a latching groove. Here, the first latching portions 120a and 120b are embodied as elastic latching blocks and are provided with oblique surfaces with a guiding function, and the second latching portions 220a and 220b are embodied as latching grooves. However, the present invention is not limited thereto.

Moreover, the antenna assembly 200 in the present embodiment further includes a base 240, wherein the base is provided with a bottom surface 242 and an opening 244. The second sliding portions 210a, 210b and the second latching portions 220a, 220b are arranged on the bottom surface 242 of the base 240, and the second connector 230 penetrates through the opening 244 and is exposed outside the base 240. In another embodiment, please refer to FIG. 3B, in order to improve the waterproof effect, the antenna assembly 200′ in the present embodiment further includes a waterproof ring 290 configured on the bottom surface 242 of the base 240. Through the design of the waterproof ring 290, it can prevent rainwater from seeping into the gap between the antenna assembly 200′ and the vehicle roof plate P (please refer to FIG. 1C) and influencing the electrical performance of the Telematics-Box 100 (see FIG. 1C).

Please refer to FIG. 1B, FIG. 1C, FIG. 4A and FIG. 4B at the same time. The antenna assembly 200 in the present embodiment further includes at least one antenna element (six antenna elements 250a, 250b, 250c, 250d, 250e, 250f are schematically illustrated) and a circuit board 260. The antenna elements 250a, 250b, 250c, 250d, 250e, 250f and the second connector 230 are respectively arranged on two opposite sides of the circuit board 260, and electrically connected to the circuit board 260. Herein, antenna elements 250a, 250b, 250c, 250d, which are, for example, 4G/LTE (Long Term Evolution) antennas, such as LTE 4×4 MIMO, can achieve Giga downlink speed. Further, the antenna elements 250a and 250b are respectively, for example, helical cylindrical antennas, and the antenna elements 250c and 250d are respectively, for example, flexible circuit board antennas, wherein the antenna elements 250c and 250d face to each other and are located between the antenna elements 250a and 250b. The antenna element 250e, for example, is a GPS (Global Positioning System) active antenna, and is electrically connected to the circuit board 260 through an amplifier circuit 265. The antenna element 250f, for example, is an AM/FM wound antenna, and is provided between the antenna element 250a and the antenna elements 250c and 250d. Accordingly, it can be seen that the antenna assembly 200 in the present embodiment is embodied as a six-in-one antenna assembly. Of course, in other non-illustrated embodiments, the type and number of the antenna elements may be customized according to the requirements, which are not limited herein.

Further, the antenna assembly 200 in the present embodiment further includes a cover body 270, in which at least one stabilizing plate (two stabilizing plates 271 are schematically illustrated) is provided. Each stabilizing plate 271 is provided with a positioning surface 272 and a supporting surface 274. The supporting surface 274 is connected to the positioning surface 272, and the antenna elements 250c and 250d (i.e., the flexible circuit board antennas) may be respectively attached to the supporting surface 274. The positioning surface 272 is provided with a first positioning portion 273, and the antenna elements 250c and 250d (i.e., the flexible circuit board antennas) are respectively provided with a second positioning portion 253. The second positioning portion 253 is positioned at the first positioning portion 273, such that the antenna elements 250c and 250d (i.e., the flexible circuit board antenna) may be respectively positioned on the positioning surface 272. More preferably, one of the first positioning portion 273 and the second positioning portion 253 is a positioning column, and the other of the first positioning portion 273 and the second positioning portion 253 is a positioning hole. Herein, the first positioning portion 273 is embodied as a positioning column, and the second positioning portion 253 is embodied as a positioning hole. However, the present invention is not limited thereto. It is worth mentioning that the stabilizing plate 271 may be designed correspondingly in different connection ways according to customization requirements to provide various types of antennas, such as horn antennas, millimetre wave antennas, micro-strip antennas, patch antennas or other array antennas firmly provided within the cover body 270, which are not used for limiting the scope of the present invention.

In addition, refer to FIG. 3A. The antenna assembly 200 in the present embodiment further includes at least one oblique surface portion (two oblique surface portions 280a and 280b are schematically illustrated), and each of the second sliding portions 210a and 210b includes two branches 212a, 212b, 214a, 214b separated by grooves C1, C2. The oblique surface portion 280a is connected with the branches 212a and 214a and is located between the groove C1 and the second latching portion 220a. The oblique surface portion 280b is connected with the branches 212b and 214b and is located between the groove C2 and the second latching portion 220b. Herein, the design of the oblique surface portions 280a and 280b may have a guiding function.

In addition, please refer to FIG. 1B and FIG. 5C. In order to effectively fix the base 240 of the antenna assembly 200 and the circuit board 260 and fix the cover body 270 and the circuit board 260, the vehicle antenna module 10 in the present embodiment further includes at least one locking member (a plurality of locking members 320 and a plurality of locking members 330 are schematically illustrated). The circuit board 260 is fixed on the base 240 through the locking members 320, wherein the locking members 320 are downwards locked from the circuit board 260 to the bottom surface 242 of the base 240. The cover body 270 is fixed on the base 240 through the locking members 330, wherein the locking members 330 are upwards locked from the bottom surface 242 of the base 240 to the cover body 270.

With respect to the assembling, firstly, please refer to FIG. 2A and FIG. 2B. A Telematics-Box 100 is fixed to a vehicle roof plate P. In detail, the Telematics-Box 100 and locking members 310 may be firstly provided to the vehicle roof plate P. Next, the locking members 310 are enabled to be locked on fixed portions 140 through locking holes H in the vehicle roof plate P, such that the Telematics-Box 100 is fixed on the vehicle roof plate P. At this time, the first sliding portions 110a, 110b, the first latching portions 120a, 120b and the first connector 130 of the Telematics-Box 100 protrude out of the assembling holes T1 and T2 in the vehicle roof plate P.

Then, please refer to FIG. 1B, FIG. 3A and FIG. 5C. The antenna assembly 200 is arranged on the vehicle roof plate P, and the vehicle roof plate P is located between the antenna assembly 200 and the Telematics-Box 100. In detail, the base 240 may be provided firstly, the base 240 is provided with a bottom surface 242 and an opening 244, and the second sliding portions 210a, 210b and the second latching portions 220a and 220b are arranged on the bottom surface 242 of the base 240. Then, the circuit board 260 provided with antenna elements 250a, 250b, 250c, 250d, 250e, 250f is fixed on the base 240 through the locking members 320. Herein, the antenna elements 250a, 250b, 250c, 250d, 250e, 250f and the second connector 230 are respectively arranged on the two opposite sides of the circuit board 260 and electrically connected to the circuit board 260, and the second connector 230 penetrates through the opening 244 and is exposed outside the base 240. After that, the cover body 270 is fixed on the base 240 through the locking members 330, and the cover body 270 covers the circuit board 260 and the antenna elements 250a, 250b, 250c, 250d, 250e, 250f.

After that, please refer to FIG. 2A, 3A, 5A, 5B, 5D and 5E, a first force F1 is applied to the antenna assembly 200 such that, when the second sliding portions 210a and 210b of the antenna assembly 200 slide along the first sliding portions 110a and 110b of the Telematics-Box 100, the first latching portions 120a and 120b guide the oblique surface portions 280a and 280b to move towards a first direction D1, and accordingly, the second latching portions 220a and 220b are latched to the first latching portions 120a and 120b, and the second connector 230 is electrically connected to the first connector 130. At this time, the antenna assembly 200 is slidably arranged on the Telematics-Box 100.

In the present embodiment, since the first latching portions 120a and 120b are embodied as elastic latching blocks with oblique surfaces having a guiding function, when the antenna assembly 200 is subjected to the first force F1 (e.g., a pushing force) such that the second sliding portions 210a, 210b slide along the first sliding portions 110a, 110b of the first latching portions 120a, 120b, the oblique surface portions 280a, 280b are guided by the first latching portions 120a, 120b and slide towards the first direction D1. In addition, the first latching portions 120a and 120b are pressed to be deformed elastically and pass through the first latching portions 120a and 120b, such that the second latching portions 220a, 220b are latched to the first latching portions 120a, 120b. At this time, the second connector 230 of the antenna assembly 200 may be structurally and electrically connected to the first connector 130 of the Telematics-Box 100.

Since the second connector 230 of the antenna module 200 can be directly connected with the first connector 130 of the Telematics-Box 100 through the structural design of the vehicle antenna module 10 in the present embodiment, compared with the method of electrically connecting the Telematics-Box and the antenna module by means of wire connection, the vehicle antenna module 10 in the present embodiment can directly convert the radio communication signals as analog ones received by the antenna module 200 into digital signals through the Telematics-Box 100, which can effectively reduce interference and reduce the high-frequency communication loss, can also reduce the amount of used coaxial cables, and thus reduces the production cost.

In addition, when disassembling, please referring to FIG. 2A, FIG. 3A, FIG. 5A, FIG. 5B, FIG. 5C, FIG. 5D and FIG. 5E again, one end of the antenna assembly 200 may be latched through a disassembling tool 20, for example, and a second force F2 (e.g., a downward pressing force) is applied to the antenna assembly 200 to deform the first latching portions 120a and 120b. Thereafter, when a third force F3 is applied to the antenna module 200 to enable the oblique surfaces 280a and 280b to move in a second direction D2 opposite to the first direction D1, the second latching portions 220a and 220b do not interfere with the first latching portions 120a and 120b, the second sliding portions 210a and 210b do not interfere with the first sliding portions 110a and 110b, and the second connector 230 does not interfere with the first connector 130, such that the antenna assembly 200 is disassembled from the Telematics-Box 100.

In short, in the assembling method for the vehicle antenna module 10 in the present embodiment, when the second sliding portions 210a and 210b of the antenna module 200 are enabled to slide along the first sliding portions 110a and 110b through the pushing force, the second latching portions 220a and 220b are latched to the first latching portions 120a and 120b, and the second connector 230 is electrically connected to the second connector 130. Therefore, the antenna assembly 200 can be assembled on the Telematics-Box 100 by means of slidable connection, and thus the assembling process can be simplified. In addition, when disassembling, the antenna assembly 200 can be disassembled from the Telematics-Box 100 by adopting the disassembling tool 20 or by the user through directly applying a force to the antenna assembly 200 to enable the first latching portions 120a and 120b to be deformed firstly, and thus the disassembling process can be simplified.

In conclusion, in the design of the vehicle antenna module in the present invention, the Telematics-Box is fixed on the vehicle roof plate, the antenna module is slidably arranged on the Telematics-Box, and the second connector of the antenna module is electrically connected to the first connector of the Telematics-Box. Compared with the method of electrically connecting the Telematics-Box and the antenna module by means of wire connection, the vehicle antenna module in the present invention can directly convert radio communication signals as analog ones received by the antenna module into digital signals through the Telematics-Box, which can effectively reduce interference and reduce the high-frequency communication loss, can also reduce the amount of used coaxial cables, and thus reduces the production cost. In addition, the stabilizing plate is provided in the cover body of the antenna assembly, the stabilizing plate may be designed correspondingly in different connection ways according to customization requirements to provide various types of antennas, such as horn antennas, millimetre wave antennas, micro-strip antennas, patch antennas or other array antennas firmly provided within the cover body, such that the vehicle antenna module in the present invention can be effectively adjusted and expanded.

It should be finally noted that the above embodiments are merely intended for describing the technical solutions of the present invention other than limiting the present invention. Although the present invention is described in detail with reference to the foregoing embodiments, persons of ordinary skill in the art should understand that they can still make modifications to the technical solutions described in the foregoing embodiments or make equivalent substitutions to some technical features thereof, without departing from scope of the technical solutions of the embodiments of the present invention.

What is claimed is:

1. A vehicle antenna module, adapted to be assembled with a vehicle roof plate, the vehicle antenna module comprising:
a Telematics-Box, fixed on the vehicle roof plate and comprising at least one first sliding portion, at least one first latching portion and a first connector, the at least one first sliding portion, the at least one first latching portion and the first connector protruding out of at least one assembling hole in the vehicle roof plate; and
an antenna assembly, slidably arranged on the Telematics-Box, the vehicle roof plate being located between the antenna assembly and the Telematics-Box, the antenna assembly comprising at least one second sliding portion, at least one second latching portion and a second connector, wherein when the at least one second sliding portion slides along the at least one first sliding portion, the at least one second latching portion is latched to the at least one first latching portion, such that the second connector is electrically connected to the first connector.

2. The vehicle antenna module according to claim 1, wherein one of the at least one first sliding portion and the at least one second sliding portion is a sliding groove, and the other of the at least one first sliding portion and the at least one second sliding portion is a sliding block.

3. The vehicle antenna module according to claim 1, wherein one of the at least one first latching portion and the at least one second latching portion is an elastic latching block, and the other of the at least one first latching portion and the at least one second latching portion is a latching groove.

4. The vehicle antenna module according to claim 1, further comprising:
at least one locking member, the Telematics-Box further comprising at least one fixed portion, the at least one locking member penetrating through the vehicle roof plate and being locked on the at least one fixed portion, such that the Telematics-Box is fixed to the vehicle roof plate.

5. The vehicle antenna module according to claim 1, wherein the Telematics-Box further comprises a housing and a circuit board, the housing comprises an opening, the circuit board is configured in the housing, the opening exposes a part of the circuit board, the at least one first sliding portion and the at least one first latching portion are located on the housing, and the first connector is electrically connected with the circuit board, penetrates through the opening and is exposed outside the housing.

6. The vehicle antenna module according to claim 1, wherein the antenna assembly further comprises a base, the base is provided with a bottom surface and an opening, the at least one second sliding portion and the at least one second latching portion are arranged on the bottom surface of the base, and the second connector penetrates through the opening and is exposed outside the base.

7. The vehicle antenna module according to claim 6, wherein the antenna assembly further comprises a waterproof ring configured on the bottom surface of the base.

8. The vehicle antenna module according to claim 1, further comprising:
at least one locking member, the antenna assembly further comprising a base, a circuit board and at least one antenna element, the at least one antenna element and the second connector being respectively arranged on two opposite sides of the circuit board and electrically connected to the circuit board, the circuit board being fixed on the base through the at least one locking member.

9. The vehicle antenna module according to claim 8, wherein the at least one antenna element comprises a 4G/LTE antenna, a GPS active antenna or an AM/FM wound antenna, the 4G/LTE antenna comprises two helical cylindrical antennas and two flexible circuit board antennas, and the two flexible circuit board antennas are opposite to each other and are located between the two helical cylindrical antennas.

10. The vehicle antenna module according to claim 1, wherein the antenna assembly further comprises a cover body and at least one antenna element, the cover body is internally provided with at least one stabilizing plate, the at least one stabilizing plate is provided with a positioning surface and a supporting surface, the supporting surface is connected to the positioning surface, the at least one antenna element is attached to the supporting surface, the positioning surface is provided with a first positioning portion, the at least one antenna element is provided with a second positioning portion, and the second positioning portion is positioned at the first positioning portion such that the at least one antenna element is positioned on the positioning surface, wherein one of the first positioning portion and the second positioning portion is a positioning column, and the other of the first positioning portion and the second positioning portion is a positioning hole.

11. The vehicle antenna module according to claim 10, further comprising:
at least one locking member, the antenna assembly further comprising a base, the cover body being fixed on the base through the at least one locking member.

12. The vehicle antenna module according to claim 1, wherein the antenna assembly further comprises at least one oblique surface portion, each of the at least one second sliding portion comprises two branches separated by a groove, and each of the at least one oblique surface portion is connected with the two branches, wherein each of the at least one oblique surface portion is connected to the two branches and is located between the groove and each of the at least one second latching portion.

13. An assembling method for a vehicle antenna module, comprising:
fixing a Telematics-Box to a vehicle roof plate, the Telematics-Box comprising at least one first sliding portion, at least one first latching portion and a first connector, the at least one first sliding portion, the at least one first latching portion and the first connector protruding out of at least one assembling hole in the vehicle roof plate;
providing an antenna assembly on the vehicle roof plate, the vehicle roof plate being located between the antenna assembly and the Telematics-Box, the antenna assembly comprising at least one second sliding portion, at least one second latching portion and a second connector; and
applying a first force to the antenna assembly such that, when the at least one second sliding portion slides along the at least one first sliding portion, the at least one second latching portion is latched to the at least one first latching portion and the second connector is electrically connected to the first connector, and accordingly, the antenna assembly is slidably arranged on the Telematics-Box.

14. The assembling method for the vehicle antenna module according to claim 13, wherein the antenna assembly further comprises at least one oblique surface portion, each of the at least one second sliding portion comprises two branches separated by a groove, and each of the at least one oblique surface portion is connected with the two branches, wherein each of the at least one oblique surface portion is connected to the two branches and is located between the groove and each of the at least one second latching portion, and when the first force is applied to the antenna assembly, the at least one first latching portion guides the at least one oblique surface portion to move towards a first direction, such that the at least one second latching portion is latched to the at least one first latching portion.

15. The assembling method for the vehicle antenna module according to claim 14, further comprising:
applying a second force to the antenna assembly to deform the at least one first latching portion; and
applying a third force to the antenna assembly such that, when the at least one oblique surface portion moves towards a second direction opposite to the first direction, the at least one second latching portion does not interfere with the at least one first latching portion, the at least one second sliding portion does not interfere with the at least one first sliding portion, and the second connector does not interfere with the first connector, and accordingly, the antenna assembly is disassembled from the Telematics-Box.

16. The assembling method for the vehicle antenna module according to claim 13, wherein the step of fixing the Telematics-Box to the vehicle roof plate comprises:
providing at least one locking member, the Telematics-Box further comprising at least one fixed portion; and
enabling the at least one locking member to penetrate through the vehicle roof plate and be locked on the at least one fixed portion, such that the Telematics-Box is fixed on the vehicle roof plate.

17. The assembling method for the vehicle antenna module according to claim 13, wherein the step of providing the antenna assembly comprises:
providing a base, the base being provided with a bottom surface and an opening, the at least one second sliding portion and the at least one second latching portion being arranged on the bottom surface of the base;
fixing a circuit board provided with at least one antenna element on the base, the at least one antenna element and the second connector being respectively arranged on two opposite sides of the circuit board and electrically connected to the circuit board, the second connector penetrating through the opening and being exposed outside the base; and
fixing a cover body on the base, the cover body covering the circuit board and the at least one antenna element.
